(19) United States
(12) Patent Application Publication
(10) Pub. No.: US 2010/0276390 A1
(43) Pub. Date: Nov. 4, 2010

(54) METHOD OF MASTERING PRECISE DOT ARRAY FOR BIT-PATTERNED MEDIA

(75) Inventors: Sundeep CHAUHAN, Fremont, CA (US); David Kuo, Palo Alto, CA (US); Kim Yang Lee, Fremont, CA (US)

Correspondence Address: SEAGATE TECHNOLOGY Outside Counsel Dergosits;& Noah LLP, Three Embarcadero Center, Suite 410, San Francisco, CA, 94111, US

(73) Assignee: Seagate Technology LLC, Scotts Valley, CA (US)

(21) Appl. No.: 12/434,555

(22) Filed: May 1, 2009

(51) Int. Cl. B44C 1/22; C23F 1/08

(52) U.S. Cl. 216/22; 156/345.54

(57) ABSTRACT

A method of producing bit-patterned media master is provided whereby down-track and cross-track deflection plates are used to position an electronic beam at two (or more) adjacent tracks during the same revolution. Adjacent tracks of a bit-patterned media can be mastered simultaneously in the present invention by keeping the electronic beam ON during the entire time that the master is being created and the deflection plates are used to quickly ping-pong the electronic beam between the two (or more) adjacent tracks.

### FIELD OF THE INVENTION

The present invention relates to the manufacture of magnetic disks and, more particularly, a method of creating a master bit-patterned media disk.

### BACKGROUND OF THE INVENTION

Hard disk drives have developed as an efficient and cost effective solution for data storage. Since the introduction of the first magnetic disk drive, storage density capabilities have increased by many orders of magnitude, with an average steady increase of nearly fifty percent per year. Main stream technology has consisted of storing information on continuous granular media having out-of-plane anisotropy and being associated with a soft underlayer which helps concentrate the magnetic flux underneath the write pole of the head, thus increasing the write field efficiency.

However, it is generally accepted that this technology will reach its limit at an areal density between 500 Gbit/in² and 1 Terabit/in². This limit is set by the so-called “recording trilemma” which is the difficulty to reconcile three requirements of magnetic recording technology: i) a sufficient number of grains per bit to insure a large enough signal to noise ratio, ii) a sufficient stability of the magnetization of each grain against thermal fluctuations, iii) the ability to switch the magnetization of the grain with the field available from the write head. Several solutions are under investigation to circumvent this trilemma, including Heat Assisted Magnetic Recording (HAMR), Microwave Assisted Magnetic Recording (MAMR), bit-patterned media, with combinations of these approaches also being possible.

Bit-patterned media, in particular, presents one of the most promising methods to overcome the density limitations imposed by the trilemma. In conventional media, the magnetic recording layer is a thin film of a magnetic alloy, which naturally forms a random mosaic of nanometer-scale grains that behave as independent magnetic elements. Each recorded bit is made up of many of these random grains. In bit-patterned media, on the other hand, the magnetic layer is created as an ordered array of highly uniform islands or dots, each dot being capable of storing an individual bit. FIG. 1 depicts an exemplary recording disk 104 comprising an array of magnetic dots 108. Each magnetic dot 108 is capable of storing a single bit of information.

One challenge associated with bit-patterned media is in the creation of a bit-patterned media master disk. One of the very first steps in making the bit-patterned media is the creation of a master, which is then used to make the copies and finally these copies are used to make stampers for the bit-patterned media print process. The positional accuracy of the bits is extremely important during the mastering process, since all of the errors in the master propagate and possibly amplify through the subsequent disks. Even worse, compensation for errors in the master is not possible and the proliferation of errors from the master cannot be controlled. Until now, the bit-patterned media master pattern has been created one pass at a time. Unfortunately, the accuracy of dot placement using these traditional methods is less than perfect due to the following somewhat uncontrollable factors: (1) larger mechanical disturbances (e.g., environmental factors, disk flutter, bearing inaccuracies, etc.) from track to track; (2) jitter due to electronic-beam blanking switching; (3) electronic beam deflection jitter; and (4) electronic beam current variation.

### SUMMARY OF THE INVENTION

These and other shortcomings of the prior art are addressed by embodiment of the present invention. More particularly, the present invention provides advantages over the prior art in that an efficient and accurate method of mastering bit-patterned media is provided. The method generally comprises:

exposing a first area of resist to an electronic beam for a predetermined amount of time sufficient to create a first media dot in a first row of media dots;

deflecting the electronic beam to a second area of resist; and

exposing the second area of resist to the electronic beam for a predetermined amount of time sufficient to create a first media dot in a second row of media dots.

In accordance with at least some embodiments of the present invention, the electronic beam may be on or activated during the deflection step. Accordingly, it is one aspect of the present invention to enhance the efficiency with which bit-patterned media is mastered by allowing the electronic beam to be on during the entire mastering process or at least during each revolution of the substrate.

Traditionally, the mastering process could take up to several days to complete. Utilizing embodiments of the present invention, the bit-patterned media mastering process throughput is increased since the electronic beam is on all of the time and the efficiency of the process is nearly 100%. Accordingly, the amount of time needed to complete the mastering process can be reduced by days, thereby allowing a significant savings of money and resources. The only energy that gets wasted during the mastering process is the energy produced by the electronic beam during the deflection step. However, since the deflection step occurs so rapidly, the amount of energy wasted is minimal.

The above-described embodiments and configurations are not intended to be complete nor exhaustive. As will be appreciated, other embodiments of the invention are possible utilizing, alone or in combination, one or more features set forth above or described below.

### BRIEF DESCRIPTION OF THE DRAWINGS

Several drawings have been developed to assist with understanding the invention. Following is a brief description of the drawings that illustrate the invention and its various embodiments.

FIG. 1 is a perspective view of individual bit cells in a bit-patterned media;

FIG. 2 is a block diagram depicting a mastering system in accordance with at least some embodiments of the present invention;

FIG. 3 is a perspective view of components in a bit-patterned media mastering system in accordance with at least some embodiments of the present invention;

FIG. 4 depicts Mox and Moy deflection waveforms used during bit-patterned media mastering in accordance with at least some embodiments of the present invention;

FIG. 5 depicts a staggered dot array pattern of a bit-patterned media master in accordance with at least some embodiments of the present invention;

FIG. 6 depicts a prior art method of writing a bit-patterned media master; and

FIG. 7 depicts a method of writing a bit-patterned media master in accordance with at least some embodiments of the present invention.

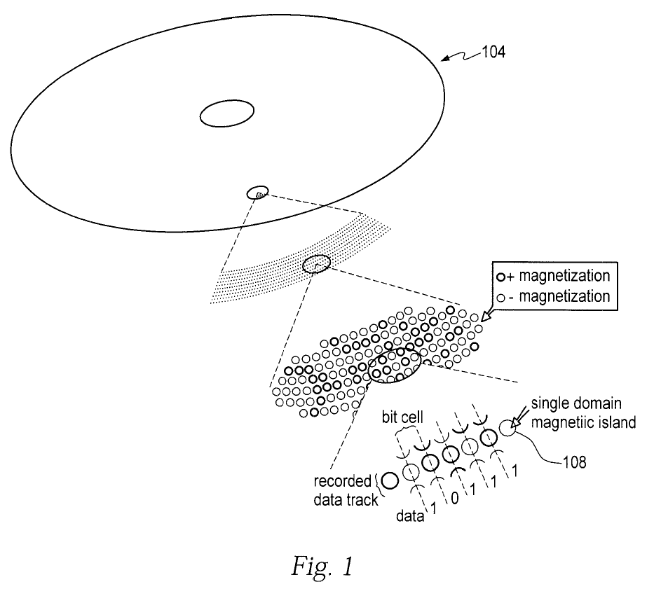

It should be understood that the drawings are not necessarily to scale, and that in certain instances, the disclosure may not include details which are not necessary for an understanding of the present invention, such as conventional details of fabrication and assembly, by those of skill in the art. Also, while the present disclosure describes the invention in connection with those embodiments presented, it should be understood that the invention is not strictly limited to these embodiments.

### DETAILED DESCRIPTION

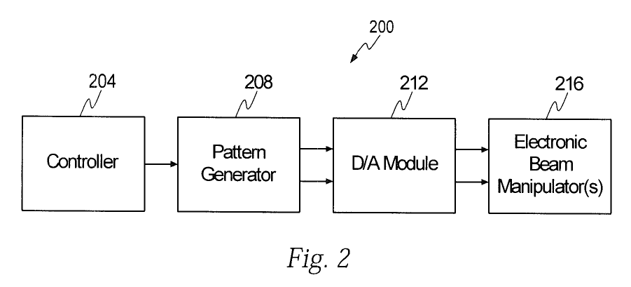

With reference now to FIG. 2, an exemplary system 200 for mastering bit-patterned media will be described in accordance with at least some embodiments of the present invention. The system 200 generally comprises a controller 204, a pattern generator 208, a digital-to-analog module 212 and an electronic beam manipulator(s) 216.

The controller 204 is adapted to generally control the overall mastering process including rotation of the media substrate as well as determining how long each area on the substrate (or a resist on the substrate) should be exposed to an electronic beam to create a dot. Accordingly, the controller 204 may be provided with logic to control the decisions that need to be made during the mastering process or determine that human intervention is required to address a particular issue. To support its decision making ability, the controller 204 may also be provided with inputs from external devices or sensors (e.g., feedback inputs relating to the current position of the electronic beam manipulator(s) 216, feedback inputs relating to substrate rotation speed, feedback inputs relating to electronic beam strength, feedback inputs relating to environmental temperatures, pressures, moisture, and so on).

Based on information received from these various inputs, the controller 204 makes a control decision and provides a control input to the pattern generator 208. The pattern generator 208 is basically a waveform generator that is operable to generate a control waveform that can be transferred to and understood by the electronic beam manipulator(s) 216.

After the pattern generator 208 has generated the appropriate waveform or waveforms, depending upon the number of manipulators in the electronic beam manipulator(s) 216, the pattern generator 208 forwards the waveform(s) to the electronic beam manipulator(s) 216. In the event that the pattern generator generates a digital waveform, the waveform is first passed through the digital-to-analog module 212, which converts the digital waveform to an analog waveform and then forwards the analog version of the waveform to the electronic beam manipulator(s) 216.

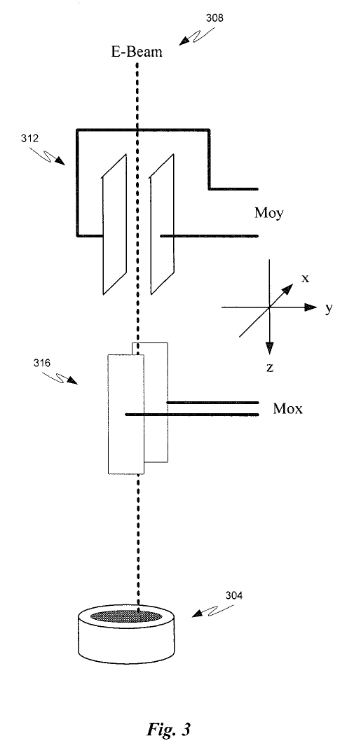

The electronic beam manipulator(s) 216 receive the control waveform(s) and adjust the position of the electronic beam accordingly. As can be seen in FIG. 3, and in accordance with at least one embodiment of the present invention, the electronic beam manipulator(s) 216 may comprise two or more deflectors 312, 316. Each deflector 312, 316 is adapted to receive a different control waveform (or possibly a copy of the same control waveform) and control the electronic beam 308 according to that particular waveform. In accordance with at least some embodiments of the present invention, a first control waveform is provided to the first deflector 312 and a second control waveform is provided to the second deflector 316. The first and second control waveforms do not necessarily need to be the same.

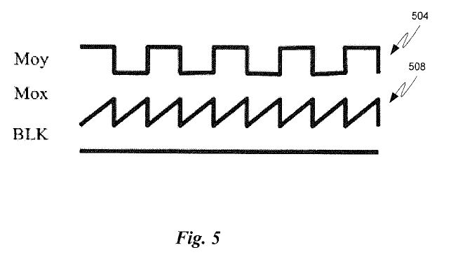

One example of waveforms provided to the first and second deflectors 312, 316, respectively, is depicted in FIG. 5. As can be seen in FIG. 5, the first deflector 312 may receive a square waveform 504 while the second deflector 316 receives a sawtooth waveform 508. The ramp of the sawtooth waveform 508 is used to track the motion of the substrate 304 with the electronic beam 308 thereby allowing the electronic beam 308 to maintain a fixed position relative to the substrate for a predetermined amount of time. This allows an area of resist on the surface of the substrate 304 to be exposed to the electronic beam 308 for a predetermined amount of time sufficient to cure that area of resist and create a substantially circular dot (i.e., a media dot). After the area of resist has been exposed to the electronic beam 308 for this predetermined amount of time, the first and second deflectors 312, 316 both simultaneously deflect the electronic beam 308 along both axes, causing the electronic beam 308 to move to a new area on the substrate 304. In accordance with at least some embodiments of the present invention, when both deflectors 312, 316 simultaneously cause the electronic beam 308 to move, the electronic beam 308 is moved from a first row of dots to a second row of dots and a new dot in the second row is created by exposing the area of resist to the electronic beam 308 for a predetermined amount of time sufficient to create a media dot.

Referring back to FIG. 3, the first deflector 312 may be employed to control or guide the electronic beam 308 in a first direction (i.e., along with y-axis) while the second deflector 316 may be employed to control or guide the electronic beam 308 in a second direction (i.e., along the x-axis). The deflectors 312, 316 may comprise any type of element or collection of elements adapted to manipulate an electronic beam such as mirrors, lenses, etc.

In accordance with at least some embodiments of the present invention, the deflectors 312, 316 comprise a pair of capacitive plates through which the electronic beam 308 passes. The relative voltage applied to each plate in the pair of capacitive plates may be adjusted, thereby altering the electronic field between the plates. This alteration of the electronic field between the plates may cause the electronic beam 308 to be deflected along either the x or y-axis, depending upon the orientation of the plates in the deflector 312, 316. If there is no difference in voltage between the two plates, then the electronic beam 308 will pass through the plates without having its path altered. However, if there is a difference in voltage between the two plates in a deflector, then the electronic beam 308 will be “bent” or otherwise have its trajectory manipulated as it passes through the deflector. This enables the deflectors 312, 316 to guide the electronic beam 308 based on the voltage waveforms applied to one plate while maintaining the other plate at a substantially constant voltage (e.g., the base voltage depicted in FIG. 5).

In accordance with at least some embodiments of the present invention, the y-axis may be oriented substantially parallel to a radial line emanating from the center of the substrate 304 which is being mastered. The x-axis may be oriented substantially orthogonal to the y-axis and may lie in the same plane as the y-axis (i.e., the plane corresponding to the top surface of the substrate 304). Moreover, the x-axis may be oriented substantially parallel to a line which is tangential to the outer edge of the substrate (assuming the substrate is circular or cylindrical). Accordingly, the electronic beam 308 is directed toward the substrate 304 and travels in the direction of the z-axis while the deflectors 312, 316 control the positioning of the electronic beam 308 along the x and y-axis.

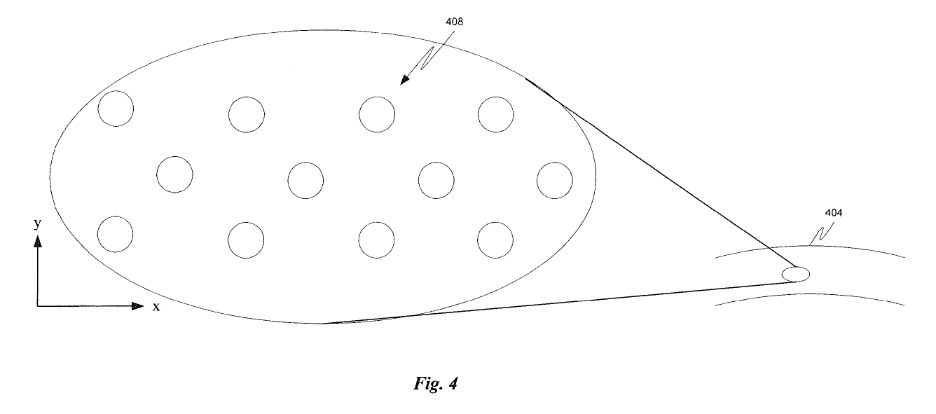

As can be seen in more detail in FIG. 4, the electronic beam 308 may be manipulated by the deflectors 312, 316 to create an array of dots 408 on the substrate 304. The array of dots 408 may be organized such that there are rows of dots aligned in tracks, where each track or row is a predetermined radial distance away from the center of the substrate. The outermost track or row of dots is closest to the outer circumference 404 of the substrate 304. The next outermost track or row of dots also traverses the substrate with a circular orientation and is slightly closer (e.g., on the order of nanometers) to the center of the substrate 304. Each track or row of dots is radially closer (along the y-axis) to the center of the substrate 304 than its outer neighbor.

As can be seen in FIG. 4, the down-track direction substantially corresponds to the x-axis. Furthermore, the array of dots 408 comprises a staggered pattern such that each adjacent row or track of dots is 180 degrees out of phase. In other words, each dot in a first row is substantially the same distance away from the two nearest dots in an adjacent second row, with the rows having different radial displacements along the y-axis. Also, the distance along the x-axis between the nearest dots in adjacent rows is substantially one half the distance along the x-axis between nearest dots in the same row. This orientation helps to maximize the density of dots in the array 408 and, therefore, maximize media density in the substrate 304. Accordingly, it is important to ensure that dot placement, especially in the media master, is executed with as much accuracy as possible, since any errors in dot placement will propagate and likely amplify in substrates made with the media master.

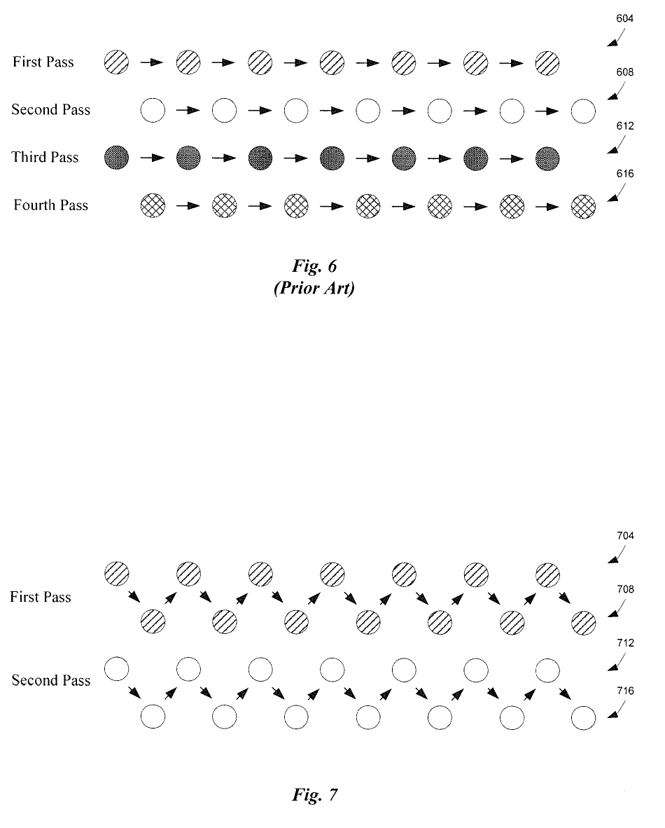

As can be seen in FIG. 6, media masters were created in the prior art by writing or mastering one row of dots 604, 608, 612, 616 at a time. In other words, a single pass or rotation of the substrate 304 was used to create a single row of dots. After a first row of dots was mastered, the electronic beam 308 would be manipulated in the y-direction and the next row of dots would be mastered. Thus, the electronic beam 308 would only be moved in the y-direction after an entire row of dots had been mastered. This particular method of mastering bit-patterned media has the potential of introducing dot placement errors because there may be a higher chance of mechanical disturbances when moving from track to track. Also, given the distance between dots in the same row, it is necessary to switch the electronic beam 308 on and off between dots. This switching can cause jitter and further introduce errors into dot placement.

With reference now to FIG. 7, a more efficient and accurate method of mastering bit-patterned media is depicted in accordance with at least some embodiments of the present invention. The proposed idea employs both down-track (x-direction) and cross-track (y-direction) deflection of the electronic beam 308 during a single pass or rotation of the substrate 304. In other words, two or more tracks or rows of dots are created during a single pass or rotation of the substrate 304. Since neighboring dots in adjacent rows (e.g., the first and second rows 704 and 708) are closer than neighboring dots in the same row (e.g., the first row 704), multiple tracks or rows of dots can be mastered during the same rotation of the substrate 304. Furthermore, the electronic beam 308 can be on the entire time (i.e., there is no need to switch the electronic beam 308 on and off) since the distance between dots on adjacent rows are closer. This increases the efficiency of the mastering process and also reduces jitter introduced into the system since electronic beam switching is eliminated.

In operation, a first area in the first row 704 is exposed to the electronic beam 308 for a predetermined amount of time sufficient to cure a resin on the substrate 304 and, thereby, permanently create a dot on the substrate. This predetermined amount of time is typically around 200 ns, but may vary depending upon the strength of the electronic beam, the characteristics of the resin, and other design considerations.

During the predetermined amount of time, the electronic beam 308 is manipulated along the x-axis via the second deflector 316 such that the electronic beam 308 follows the same area while the substrate 304 is rotated. This manipulation of the electronic beam 308 in the down-track direction during substrate 304 rotation helps to reduce the dragging effect or smearing of dots in the down-track direction. In other words, if the electronic beam 308 were not moved to track the rotation of the substrate 304, each dot would be slightly longer along the x-axis than it is along the y-axis.

After the predetermined amount of time has passed, the electronic beam 308 is moved to a first area in the second row 708. During this step, the first deflector 312 guides the electronic beam 308 along the y-axis from the first row 704 to the second row 708 and the second deflector 316 guides the electronic beam 308 slightly down-track (along the x-axis) to the first area in the second row 708. This particular step may take less than 1 ns. Thus, the electronic beam 308 does not need to be turned off because this short amount of time is not sufficient to cure the resin between dots. Additionally, the deflection occurs so quickly that a minimal amount of energy from the beam 308 is wasted and no energy is wasted by switching the beam 308 off.

This first area in the second row 708 is exposed to the electronic beam 308 for a predetermined amount of time sufficient to cure the resin on the substrate 304 and permanently create a dot in the second row 708.

Thereafter, the electronic beam 308 is again manipulated, but this time back to the first row 708. The first deflector 312 guides the beam 308 in a cross-track direction while the second deflector 316 guides the beam 308 in a down-track direction. Accordingly, a second area (down-track from the first area) in the first row 704 is exposed to the electronic beam 308 for a predetermined amount of time sufficient to cure the resin on the substrate 304 and permanently create another dot in the first row 704.

Again, after a predetermined amount of time has passed, the method continues with the deflectors 312, 316 moving the electronic beam 308 back to a second area (down-track from the first area) in the second row 708. This second area in the second row 708 is exposed to the electronic beam 308 for a predetermined amount of time sufficient to cure the resin on the substrate 304 and permanently create another dot in the second row 708. The method continues until the substrate has completed a rotation and the first and second rows 704, 708 have been mastered. After the first and second rows 704, 708 have been mastered, the electronic beam 308 is deflected down to the third row 712 and the third and fourth rows 712, 716 of dots are mastered similarly to the first and second rows 704, 708 (i.e., both rows are mastered during the same rotation of the substrate 304).

Although embodiments of the present invention have described the mastering of two adjacent tracks during a single rotation of a substrate, one skilled in the art will appreciate that the invention is not so limited. More specifically, embodiments of the present invention may be utilized to master more than two tracks during a single rotation of a substrate. Accordingly, an electronic beam may be moved to a first, then a second, then a third (and possibly a fourth, fifth, sixth, etc.) row before moving back to the first row to create another dot in the first row. The methodology with which the electronic beam is moved between rows may vary depending upon the number of rows that are being mastered during a single rotation and the relative orientation of dots in adjacent rows. There may be several ways of mastering three or more adjacent tracks of rows of dots during a single rotation of the substrate and such variants will become apparent after reviewing the present disclosure.

The foregoing discussion of the invention has been presented for purposes of illustration and description. The foregoing is not intended to limit the invention to the form or forms disclosed herein. In the foregoing description for example, various features of the invention have been identified. It should be appreciated that these features may be combined together into a single embodiment or in various other combinations as appropriate for the intended end use of the band. The dimensions of the component pieces may also vary, yet still be within the scope of the invention. This method of disclosure is not to be interpreted as reflecting an intention that the claimed invention requires more features than are expressly recited in each claim. Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation. Rather, as the following claims reflect, inventive aspects lie in less than all features of any single foregoing disclosed embodiment. Thus, the following claims are hereby incorporated into this Detailed Description, with each claim standing on its own as a separate preferred embodiment of the invention.

What is claimed is:

1. A method of mastering bit-patterned media, comprising:
exposing a first area of resist to an electronic beam for a predetermined amount of time sufficient to create a first media dot in a first row of media dots;
deflecting the electronic beam to a second area of resist; and
exposing the second area of resist to the electronic beam for a predetermined amount of time sufficient to create a first media dot in a second row of media dots.

2. The method of claim 1, further comprising:
deflecting the electronic beam to a third area of resist; and
exposing the third area of resist to the electronic beam for a predetermined amount of time sufficient to create a second media dot in the first row of media dots.

3. The method of claim 2, further comprising:
deflecting the electronic beam to a fourth area of resist; and
exposing the fourth area of resist to the electronic beam for a predetermined amount of time sufficient to create a second media dot in the second row of media dots.

4. The method of claim 3, wherein the second media dot in the first row of media dots is positioned down-track from the first media dot in the first row of media dots and wherein the second media dot in the second row of media dots is positioned down-track from the first media dot in the second row of media dots.

5. The method of claim 1, wherein the first row of media dots is adjacent to the second row of media dots.

6. The method of claim 1, wherein the predetermined amount of time is approximately 200 ns.

7. The method of claim 1, wherein the electronic beam is on while it is deflected from the first area to the second area.

8. The method of claim 1, wherein the first media and second media dot comprise a magnetic material and wherein the dots in the first row of media dots is 180 degrees out of phase with the dots in the second row of media dots.

9. The method of claim 1, wherein the electronic beam is deflected from the first area to the second area in less than 1 ns.

10. A system for creating a bit-patterned media master on a substrate, comprising:
an electronic beam; and
at least one manipulator operable to guide the electronic beam between at least two tracks during a single rotation of the substrate.

11. The system of claim 10, wherein the at least two tracks are adjacent tracks and wherein each track comprises a row of media dots.

12. The system of claim 10, wherein the at least one manipulator comprises first and second deflectors, wherein the first deflector is used to guide the electronic beam in a first direction and wherein the second deflector is used to guide the electronic beam in a second direction.

13. The system of claim 12, wherein the first direction is substantially orthogonal to the second direction.

14. The system of claim 12, wherein the at least one deflector comprises a set of deflection plates.

15. The system of claim 10, wherein the at least one manipulator is operable to guide the electronic beam between from a first track to a second track in less than 200 ns.

16. A method of manufacturing a bit-patterned disk for use in a disk drive, the method comprising:
creating a bit-patterned media master disk by exposing a first area of resist on the master disk to an electronic beam for a predetermined amount of time sufficient to create a first media dot in a first row of media dots, deflecting the electronic beam to a second area of resist, and exposing the second area of resist to the electronic beam for a predetermined amount of time sufficient to create a first media dot in a second row of media dots;
using the master disk to create a stamp disk; and
using the stamp disk to create a bit-patterned disk for use in a disk drive.

17. The method of claim 16, wherein first and second deflectors are used to deflect the electronic beam, wherein the first deflector is used to guide the electronic beam in a first direction and wherein the second deflector is used to guide the electronic beam in a second direction.

18. The method of claim 16, wherein the first row of media dots is adjacent to the second row of media dots.

19. The method of claim 16, wherein the electronic beam is on while it is deflected from the first area to the second area.

20. The method of claim 16, wherein the electronic beam is deflected from the first area to the second area in less than 1 ns.
